(19) United States
(12) Patent Application Publication
(10) Pub. No.: US 2021/0122875 A1
(43) Pub. Date: Apr. 29, 2021

(54) Cross-linked Nanoporous Saccharide-based Material and Methods for Fabrication Thereof

(71) Applicant: Nano and Advanced Materials Institute Limited, Hong Kong (HK)

(72) Inventors: Wing Nien Wylie O, Hong Kong (HK); Tin Lok LI, Hong Kong (HK); Zhijian LIN, Hong Kong (HK); Dan CHENG, Hong Kong (HK); Jifan LI, Hong Kong (HK)

(21) Appl. No.: 17/259,203

(22) PCT Filed: Jul. 10, 2019
(86) PCT No.: PCT/CN2019/095422

§ 371 Date: Jan. 11, 2021

Related U.S. Application Data
(60) Provisional application No. 62/763,927, filed on Jul. 11, 2018.

(51) Int. Cl. C08G 18/64; C08B 37/16; C08B 15/10; C08J 3/24

(52) U.S. Cl. CPC C08G 18/6484; C08B 37/0012; C08J 2305/16; C08J 3/24; C08J 2301/02; C08B 15/10

(57) ABSTRACT

The present invention discloses a cross-linked nanoporous saccharide-based material comprising saccharides as building blocks, also referred as nanoporous Nanosponge materials. The reaction of saccharides with cross-linkers at different saccharides to cross-linker ratios in one-pot shall allow formation of nanoporous Nanosponge material. This method further allows introduction of new functional groups on this material by the use of suitable cross-linkers and surface grafting agents, and these functional groups shall be able to provide different interaction forces with water, volatile organic vapors (VOCs) and metal ions. Along with larger inner surface area owing to the presence of nanopores or nanocavities in comparison to porous materials, saccharide-based nanoporous Nanosponge materials shall find broad applications in thermal insulation, water retention, hydrophobic finishes, odor removal properties, and metal ions exchange or absorption from water or soil. The nanoporous Nanosponge materials shall be eco-friendly, biodegradable, and allowing recycle or reuse of spent materials.

### CROSS-REFERENCE TO RELATED APPLICATIONS

This application is a 371 application of the PCT application number PCT/CN2019/095422 filed Jul. 10, 2019 claiming priority to U.S. provisional patent application No. 62/763,927, filed Jul. 11, 2018, and entitled “Versatile Super-insulating Nanoporous Material Comprising Dextrins”, which are incorporated herein by reference.

### FIELD OF THE INVENTION

Aspects described herein relate to a cross-linked nanoporous saccharide-based material and methods for fabrication.

### BACKGROUND OF THE INVENTION

Highly porous materials are desirable materials in thermal insulation applications, and are excellent sorbent materials towards, for example, water, volatile organic vapors (VOCs), metal ions, and lipids. These materials are also capable trapping plentiful of gas in their porous cavities.

Nanoporous materials with pore diameter of 100 nm and below are “super-insulating” materials. The “super-insulating” phenomenon makes uses of the Knudsen effect in which the mean free path of air molecules is larger than that of the diameter of the nanopore. This reduces the convection of gas that is confined in the nanopore; gas molecules will only collide onto the pore wall but not with another molecule. This has a total effect in the reduction of the gas thermal conductivity, and therefore, the thermal conductivity of the insulating materials.

Silica-based aerogel is one of the marketed super-insulation materials with thermal conductivity of 0.015 W/mK, and with workable temperature ranging from −40 to 650 degrees Celsius, when suitably incorporated into form factors. U.S. Pat. No. 8,021,583B2 discloses a blanket containing aerogel that can be used can be used as a window, wall, floor, and the like. U.S. Pat. No. 9,969,856B2 discloses coating composite containing a water-based polymer and aerogel for thermal insulation.

However, silica-based aerogel suffers from setbacks that limit the scope of applications in thermal insulation; namely, convoluted manufacturing processes along with high production costs, poor mechanical strength, dustiness, brittleness of the material, and potential respiratory hazard of silica dust. Silica-based aerogel also has limited scope of applications as sorbent material in the removal of contaminants from air and water; poor biodegradability and reusability of silica aerogel are also major hurdles to its use in consumer product applications.

There is a need to provide a nanoporous material to overcome one or more setbacks as described, namely, comprising eco-friendly and biodegradable starting materials, allowing recycling or reuse of spent materials, with improved mechanical strength, and can be incorporated into different form factors that involve simple manufacturing process.

Saccharides are eco-friendly and biodegradable starting materials. Cellulose and its derivatives, comprising beta-glycosidic bond, can be extracted from, for example, wood pulp, rice husk, corn hub and husk, and can be extracted from recycled materials such as paper and cotton fabric. Dextrins and cyclodextrins, comprising alpha-glycosidic bond, can be obtained from the hydrolysis or the enzymatic treatment of starch or glycogen.

U.S. Pat. No. 10,138,346B2 discloses a method of forming polysaccharide-based aerogel and their thermal properties, water and oil absorption capability. This method excludes the use of cross-linkers with cellulose, lignin, hemicellulose, chitin, arabinoxylan and pectin in the formation of the polysaccharide gel.

### SUMMARY OF INVENTION

The present invention discloses a cross-linked nanoporous saccharide-based material comprising saccharides as building blocks (also hereinafter referred to nanoporous Nanosponge materials). The reaction of saccharides with cross-linkers at different saccharides to cross-linker ratios in one-pot shall allow formation of nanoporous Nanosponge material. This method further allows introduction of new functional groups on this material by the use of suitable cross-linkers and surface grafting agents, and these functional groups shall be able to provide different interaction forces with water, volatile organic vapors (VOCs) and metal ions. Along with larger inner surface area owing to the presence of nanopores or nanocavities in comparison to porous materials, saccharide-based nanoporous Nanosponge materials shall find broad applications in thermal insulation, water retention, hydrophobic finishes, odor removal properties, and metal ions exchange or absorption from water or soil. The nanoporous Nanosponge materials shall be eco-friendly, biodegradable, and allowing recycle or reuse of spent materials.

One object of the invention is to provide a cross-linked nanoporous saccharide-based material being fabricated by reacting saccharides with cross-linkers at different saccharides to cross-linker ratios in one-pot. Drying of this material allows the formation of nanoporous Nanosponge material.

In one embodiment, monosaccharide unit of the saccharides is represented by Chemical Formula (I):

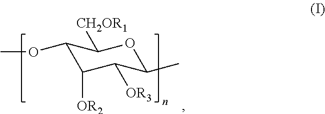

wherein R₁, R₂, R₃ is independently selected from hydrogen, methyl, ethyl, butyl, pentyl, octyl, acetyl, propionate, butyrate, benzoyl, phthalate, 2-hydroxyethyl, 2-hydroxypropyl, carboxymethyl, carboxymethyl sodium, 2-carboxyethyl sodium, sulfated sodium, t-butyldimethylsilyl, or cyanoethyl group, and n is an integer from 6 to 1,300.

In an illustrative embodiment, the saccharides of the present material are selected from cellulose, dextrins or cyclodextrins, or the derivatives thereof. When the saccharide is selected from cyclodextrins or the derivatives thereof, n in the Chemical Formula (I) is an integer ranging from 6 to 8. When the saccharide is selected from cellulose or the derivatives thereof, n in the Chemical Formula (I) is an integer ranging from 120 to 1,300.

Cellulose or derivatives comprise glucopyranose units linked by beta-(1,4′)-glycosidic bonds. They can be extracted from, for example, wood pulp, rice husk, corn hub and husk, and can be extracted from recycled materials such as paper and cotton fabric.

Dextrins, cyclodextrins, or derivatives comprise glucopyranose units linked by alpha-(1,4′)- or alpha-(1,6′)-glycosidic bonds. Both can be obtained from the hydrolysis or the enzymatic treatment of starch or glycogen. Cyclodextrins is selected from alpha-, beta-, or gamma-cyclodextrin.

Cyclodextrins or derivatives further comprise cyclic glucopyranosyl oligosaccharides, typically with 6 to 8 glucopyranose units bonded via alpha-(1,4′)-glycosidic bonds. Cyclodextrins have cavities up to 0.88 nm in diameter. The cavity interior is slightly hydrophobic, while the outer is hydrophilic owing to the presence of up to 8 functionalizable hydroxymethyl groups. These groups can participate in hydrogen-bonding interactions with molecules such as water and ammonia.

Cross-linking of cyclodextrins with each other or grafting onto a polymeric substrate creates multiple nanocavities in the resulting structure.

It is known that cyclodextrins are used in guest-host chemistry in which inclusion complexes can be formed. This intrinsic property is contributed by size-exclusion effect and Van der Waals force between the inclusion compound and the slightly hydrophobic core of cyclodextrin. This property has found applications in medical textile and in drug delivery.

In another illustrative embodiment, the cross-linkers comprising nanoporous Nanosponge materials constitute two or more functional groups, and can be homofunctional or heterofunctional, and the functional groups are selected from carboxylic acid or carboxylic acid anhydride groups, isocyanate or thiocyanate groups, vinyl groups, silyl groups, epoxy, sulfo, sulfhydryl, or amine groups.

In another illustrative embodiment, the reaction of saccharides with cross-linkers at different saccharides to cross-linker ratios in one-pot involves the use of a suitable solvent system, which will lead to the formation of a sol-gel prior to the formation of nanoporous Nanosponge materials via drying.

The saccharides to cross-linker ratio used in certain embodiments of the present invention is defined as the mole ratio of the anhydroglucose unit of the saccharide to cross-linkers, which is in a range of 1:0.1 to 1:8. In an exemplary embodiment, the mole ratio of the anhydroglucose unit of the saccharide to cross-linkers is in a range of 1:0.25 to 1:5.

In another illustrative embodiment, the fabrication of the saccharide-based nanoporous Nanosponge materials involves the drying of a porous sol-gel containing another solvent with low surface tension. The resulting nanoporous Nanosponge materials have low thermal conductivity.

In some embodiments, the another solvent with low surface tension comprises components of hydrofluoroethers, and the nanoporous sol-gel is filled with hydrofluoroethers, which is then dried at ambient temperature and pressure, or under supercritical conditions.

In other embodiments, the fabrication of the present material is carried out in a temperature ranging from −78 to 200 degree Celsius.

Optionally, one or more functional groups can also be introduced into the saccharide by reacting one or more of said cross-linkers with the monosaccharide unit of the saccharides.

Optionally, apart from the reaction of saccharide with the cross-linkers, one or more functional groups can also be introduced by reacting one or more surface grafting agents at a mole ratio of an anhydroglucose unit of the saccharide to surface grafting agent in a range of 1:1 to 1:3 during said reaction, prior to and/or after said drying.

In one embodiment, the one or more functional groups introduced by said surface grafting agents comprise epoxy, carboxylic acid, carboxylate, sulfo, sulfhydryl, hydroxyl, amine, imine, isocyanate, nitrile, silyl and C3 to C21 hydrocarbon groups, and any combinations thereof.

According to certain embodiments of the present invention, the as-fabricated cross-linked nanoporous saccharide-based material has one or more of the following features and/or capabilities: an average pore radius in a range of 0.5 to 200 nm; particle size in a range of 5 to 500 microns; bulk density in a range of 1 to 680 kg/m³; thermal conductivity from 0.015 to 0.05 W/mK; water retention capability from 1 to 520% with respect to the weight thereof; water-repellent capability with a water contact angle at 140° ; capability of absorbing ammonia in the range of 1 to 600 mg/m³ per 1 g of said material; capability of exchanging or absorbing metal ions including Cd, Cr, Pb, Cu, Zn, Co, Hg and/or Ni in a range of 0.1 to 1000 cmol of singly charged cation per kg of said material.

Another object of the invention is to provide a method for fabricating the present material comprising:

reacting saccharide of Chemical Formula (I) with one or more cross-linkers at different saccharide to cross-linker ratios by mixing said saccharide with the one or more cross-linkers as a mole ratio of anhydroglucose unit of the saccharide to cross-linker in a range of 1:0.25 to 1:5 in one-pot and in a solvent system under a temperature ranging from −78 to 200 degrees Celsius;

drying the mixture to get rid of the solvent in order to obtain the present material.

Optionally, the solvent system can be replaced by another solvent system with lower surface tension prior to said drying of the mixture to obtain the present material, wherein said another solvent comprises components of hydrofluoroethers. After replacing the initial solvent system with said another solvent system with lower surface tension, a nanoporous sol-gel is formed which is filled with hydrofluoroethers. The drying of the nanoporous sol-gel can be carried out at ambient temperature and pressure, or under supercritical conditions.

Also optionally, one or more functional groups can be introduced to the saccharides by reacting one or more of said cross-linkers with the monosaccharide unit of the saccharides at a mole ratio of anhydroglucose unit of the saccharide to cross-linker in a range of 1:0.25 to 1:5.

Also optionally, apart from reacting the saccharide with one or more cross-linkers and prior to said drying, one or more functional group can also be introduced into the saccharide by further reacting one or more surface grafting agents at a mole ratio of an anhydroglucose unit of the saccharide to said surface grafting agent in a range of 1:1 to 1:3 during said reacting, prior to and/or after said drying.

In one embodiment, the one or more functional groups introduced by said surface grafting agents comprise epoxy, carboxylic acid, carboxylate, sulfo, sulfhydryl, hydroxyl, amine, imine, isocyanate, nitrile, silyl and C3 to C21 hydrocarbon groups, and any combinations thereof.

It is known that cyclodextrins are used in guest-host chemistry in which inclusion complexes can be formed. This intrinsic property is contributed by size-exclusion effect and Van der Waals force between the inclusion compound and the slightly hydrophobic core of cyclodextrin. This property has found applications in medical textile and in drug delivery.

Other objects of the present invention include a thermally insulating and absorbing Nanosponge for gas or liquid comprising the present material according to various embodiments of the present invention, and a thermally insulated and absorbing Nanosponge for gas or liquid fabricated by the present method according to various embodiments of the present invention, with one or more of the following properties: water retention, hydrophobic finishes, odor removal, and/or metal ion exchange and absorption properties, etc.

Advantageously, the introduction of new functional groups into the saccharide-based nanoporous Nanosponge materials, along with the presence of large inner surface area owing to nanopores or nanocavities, saccharide-based nanoporous Nanosponge materials shall find broad applications in thermal insulation, water retention, hydrophobic finishes, odor removal properties, and metal ions exchange or absorption from water or soil, based on different interaction forces between the introduced functional groups and water, volatile organic vapors (VOCs) and metal ions.

### BRIEF DESCRIPTION OF DRAWINGS

The accompanying drawings illustrate the disclosed embodiments and serve to explain the principles of the disclosed embodiments. It will be understood that the drawings are designed of illustration purposes only and not as a definition of the limits of the invention.

FIG. 1 depicts the absorption profile towards ammonia of Example 7 and Comparative Example 2.

FIG. 2 depicts the absorption profile towards ammonia of Example 8.

### DETAILED DESCRIPTION OF THE INVENTION

The invention now will be described more fully hereinafter. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including”, or “provide” and/or “provides”, when used in this specification, specify the presence of stated features, regions, integers, steps, operations, elements, and/or components, but do not preclude the presence or addition of one or more other features, regions, integers, steps, operations, elements, components, and/or groups thereof.

Certain embodiments throughout this invention may be disclosed in a range format. It will be understood that the description in range format is merely for convenience and brevity and should not be interpreted as an inflexible limitation on the scope of the disclosed range. The description of a range will be considered to have specifically disclosed all of the possible sub-ranges as well as individual numerical values within that range. For example, description of a range such as from 1 to 4 should be considered to have specifically disclosed sub-ranges such as from 1 to 3, from 1 to 4, from 2 to 4 etc., as well as individual numbers within that range, for example, 1, 2, 3, 4.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “insulation” refers to the reduction of thermal energy transfer between objects in thermal contact, or in range of radiative influence.

The term “Nanosponge” refers to a class of materials with nanometric property, which can be used, including but not limited to, applications such as thermal insulation, water retention, hydrophobic finishes, odor removal properties, and metal ions exchange or absorption from water or soil.

The term “nanometric” to be interpreted broadly to include any dimensions that are less than about 1000 nm. The term “micrometric” to be interpreted broadly to include any dimensions that are 1000 nm and above.

The term “saccharide” refers to a class of materials that comprising at least one monosaccharide unit linked to each other by a glycosidic bond.

The term “monosaccharide” refers to aldoses, ketoses and a wide variety of derivatives.

The term “anhydroglucose unit” refers to a single sugar molecule containing 1 to 3 hydroxy groups.

The term “ambient temperature” refers to temperature range of 20 to 25 degrees Celsius.

The term “ambient pressure” refers to pressure at 1 atm.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein.

The nanoporous Nanosponge materials are fabricated by reacting saccharides with cross-linkers at different saccharides to cross-linker ratios in one-pot, leading to formation of a porous material. The porous material is then dried.

In one embodiment, the mixing of saccharides with cross-linkers at different saccharides to cross-linker ratios in one-pot is conducted by mechanical stirring with methods commonly understood by one of ordinary skill in the art.

The saccharide to cross-linker ratio is further defined as the mole ratio of the anhydroglucose unit of the saccharide to cross-linkers, and is in the range of 1:0.1 to 1:8. Preferably, the mole ratio of the anhydroglucose unit of the saccharide to cross- linkers is in a range of 1:0.25 to 1:5.

The said saccharides of nanoporous Nanosponge materials comprise alpha-glycosidic bond or beta-glycosidic bond.

In an exemplary embodiment, the said saccharides of nanoporous Nanosponge materials are cellulose, dextrins or cyclodextrins, or their corresponding derivatives.

In another embodiment, cyclodextrins and/or their derivatives are chosen from alpha-, beta-, or gamma-cyclodextrins.

Monosaccharide unit of the saccharides of nanoporous Nanosponge materials is represented by Chemical Formula (I). When the saccharide is selected from cyclodextrins or the derivatives thereof, n in the Chemical Formula (I) is an integer ranging from 6 to 8. When the saccharide is selected from cellulose or the derivatives thereof, n in the Chemical Formula (I) is an integer ranging from 120 to 1,300.

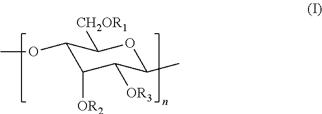

In Chemical Formula (I), R₁, R₂, R₃ can be independently selected from hydrogen, methyl, ethyl, butyl, pentyl, octyl, acetyl, propionate, butyrate, benzoyl, phthalate, 2-hydroxyethyl, 2-hydroxypropyl, carboxymethyl, carboxymethyl sodium, 2-carboxyethyl sodium, sulfated sodium, t-butyldimethylsilyl, cyanoethyl groups.

The derivatives of cellulose, dextrins or cyclodextrins of the nanoporous Nanosponge materials shall comprise combinations of monosaccharide unit represented by Chemical Formula (I). In Chemical Formula (I), R₁, R₂, R₃ can be independently selected from hydrogen, methyl, ethyl, butyl, pentyl, octyl, acetyl, propionate, butyrate, benzoyl, phthalate, 2-hydroxyethyl, 2-hydroxypropyl, carboxymethyl, carboxymethyl sodium, 2-carboxyethyl sodium, sulfated sodium, phosphate, t-butyldimethylsilyl, cyanoethyl groups.

In another embodiment, the said saccharides of nanoporous Nanosponge materials are cyclodextrin derivatives, including but not limited to 2-hydroxypropylcyclodextrin, 2-hydroxyethylcyclodextrin, cyclodextrin sulfated sodium salt, methylcyclodextrin, carboxymethylcyclodextrin sodium salt, 2-carboxyethylcyclodextrin sodium salt, acetylcyclodextrin, benzoylcyclodextrin, butylcyclodextrin.

In another embodiment, the said saccharides of nanoporous Nanosponge materials are cellulose derivatives, including but not limited to cellulose acetate, 2-hydoxyethylcellulose, hydroxypropyl cellulose, cellulose acetate butyrate, cellulose acetate phthalate, cellulose acetate propionate, cyanoethylated cellulose, methyl cellulose, ethyl cellulose, sodium carboxymethyl cellulose.

The cross-linkers comprising nanoporous Nanosponge materials constitute two or more homofunctional or heterofunctional groups selected from carboxylic acid or carboxylic acid anhydride groups, isocyanate or thiocyanate groups, vinyl groups, silyl groups, epoxy, sulfo, sulfhydryl, or amine groups.

In an exemplary embodiment, the cross-linkers comprising carboxylic acid groups, carboxylic acid anhydride groups include but not limited to hexanedioic acid, dodecanedioic acid, maleic acid, fumaric acid, aspartic acid, glutamic acid, agaric acid, tricarballylic acid, ethylenediaminetetraacetic acid, ethylenediaminetetraacetic acid disodium salt, pyromellitic anhydride, maleic anhydride, ethylenediaminetetraacetic dianhydride, diethylenetriaminepentaacetic dianhydride, cyclobutane-1,2,3,4-tetracarboxylic dianhydride, benzophenone-3,3′,4,4′-tetracarboxylic dianhydride.

In another exemplary embodiment, the cross-linkers comprising isocyanate groups and/or thiocyanate groups include but not limited to hexamethylene diisocyanate, toluene 2,4-diisocyanate, tolylene-2,6-diisocyanate, isophorone diisocyanate, ethylene dithiocyanate, p-xylylene dithiocyanate, tetramethylene dithiocyanate.

In another exemplary embodiment, the cross-linkers comprising vinyl groups include but not limited to N,N′-methylenebis(acrylamide), N,N′-ethylenebis(acrylamide), piperazine diacrylamide, ethylene glycol diacrylate, di(ethylene glycol) diacrylate, trimethylolpropane triacrylate, pentaerythritol tetraacrylate.

In another exemplary embodiment, the cross-linker comprising silyl groups including but not limited to trimethoxy(methyl)silane, triethoxy(methyl)silane, trimethoxy(ethyl)silane, triethoxy(ethyl)silane, trimethoxy(propyl)silane, triethoxy(propyl)silane, trimethoxy(isobutyl)silane, triethoxy(isobutyl)silane, dimethoxy(dimethyl)silane, diethoxy(dimethyl)silane, trimethoxy(phenyl)silane, triethoxy(phenyl)silane, 1,6-bis(trimethoxysilyl)hexane, 3-glycidoxypropyl trimethoxysilane, 3-glycidoxypropyl triethoxysilane, 3-methacryloxypropyl trimethoxysilane, 3-methacryloxypropyl triethoxysilane, 3-acryloxypropyl trimethoxysilane, 3-aminopropyl trimethoxysilane, 3-aminopropyl triethoxysilane, N-2-(aminoethyl)-3-aminopropyl trimethoxysilane, 3-isocyanatepropyl triethoxysilane, (3-mercaptopropyl) trimethoxysilane, vinyltrimethoxysilane

In another embodiment, the cross-linkers used in the mixing of saccharides at different saccharides to cross-linker ratios in one-pot shall comprise cross-linkers of one-kind, or cross-linkers of two different kinds, allowing the formation of nanoporous Nanosponge material. The ratio between cross-linkers of two different kinds can be in the range of 1:0.1 to 8.

The cross-linker shall react or cross-link with the monosaccharide unit of the saccharides of nanoporous Nanosponge materials represented by Chemical Formula (I). Reaction or cross-linking shall occur at R₁, R₂, or R₃ groups, or R₁ and R₂, or R₁ and R₃, or R₂ and R₃, or R₁ and R₂ and R₃ groups of Chemical Formula (I).

The preferred group on the monosaccharide unit of the saccharides of nanoporous Nanosponge materials represented by Chemical Formula (I) for the reaction or cross-link with the cross-linker is R₁.

The reaction of saccharides with cross-linkers at different saccharides to cross-linker ratios in one-pot can be conducted in the temperature range from −78 to 200 degrees Celsius.

The methods of drying of nanoporous Nanosponge materials are commonly understood by one of ordinary skill in the art, such as supercritical drying using carbon dioxide, freeze drying using water or with common organic solvents, drying at ambient temperature and pressure, drying at elevated temperature, drying at reduced pressure, or combinations thereof.

A suitable reaction solvent system can be optionally used in reaction of saccharides with cross-linkers at different saccharides to cross-linker ratios in one-pot, leading to formation of a porous sol-gel.

In one embodiment, the solvent system used in reaction of saccharides with cross-linkers at different saccharides to cross-linker ratios in one-pot is chosen from water, methyl ethyl ketone, toluene, dimethylformamide, dimethylacetamide, dimethyl sulfoxide, propylene carbonate and combination thereof at different mixing ratios.

The solvent system can be optionally replaced by a solvent system with low surface tension prior to the drying of porous sol-gel of the nanoporous Nanosponge material.

In one embodiment, the solvent system is first replaced by a solvent system with low surface tension, using methods that are commonly understood by one of ordinary skill in the art, such as decantation of a solvent followed by replenishing a solvent of the same or different kind, or layering of a solvent onto solvent of the same of different kind containing the porous sol-gel.

In another embodiment, the solvent system with low surface tension comprises components of any or combinations of acetone, methyl ethyl ketone, diethyl ether, pentane, hexanes, heptane, tetrahydrofuran, and hydrofluoroethers.

In another embodiment, the hydrofluoroethers are 1-methoxyheptafluoropropane (Trade name: 3M™ Novec™) or isomers of methoxynonafluorobutane (Trade name: 3M™ Novec™ 7100).

In an exemplary embodiment, the solvent for reaction is dimethylformamide, and the solvent system with low surface tension comprises acetone and hydrofluoroethers. A porous sol-gel in dimethylformamide is layered with acetone, and is allowed to settle in the range of 0.5 to 24 hours; then this solvent system is decanted and replenished with acetone again. This is repeated until dimethylformamide is completely removed. The porous sol-gel is now filled with acetone. Excess acetone is then decanted and replaced by a hydrofluoroether, and is allowed to settle in the range of 0.5 to 24 hours. This solvent system is decanted and replenished with a hydrofluoroether again. The process is repeated until acetone is completely removed. The porous sol-gel is now filled with a hydrofluoroether.

In another embodiment, the porous sol-gel of saccharide-based nanoporous Nanosponge material filled with a hydrofluoroether is dried at ambient temperature and pressure, or under supercritical conditions, leading to the formation of a nanoporous material.

Optionally, the porous materials obtained from reaction of saccharides with cross-linkers at different saccharides to cross-linker ratios in one-pot, followed by drying of the corresponding porous sol-gel, can be further cured in the absence of solvent.

The curing of saccharide-based nanoporous Nanosponge materials upon obtaining the dried porous materials from reaction of saccharides with cross-linkers at certain saccharides to cross-linkers ratio in one-pot is advantageous as to increase the degree of cross-linking with saccharides and cross-linkers.

In one embodiment, the temperature for curing the dried porous materials obtained from mixing of saccharides with cross-linkers at different saccharides to cross-linker ratios in one-pot is in the range of 30 to 200 degrees Celsius.

The saccharide-based nanoporous Nanosponge materials that are fabricated according to the methods disclosed in the present invention will have a low thermal conductivity value. The thermal conductivity values are in the range of 0.015 to 0.200 W/mK, preferably in the range of 0.015 to 0.100 W/mK, and more preferably in the range of 0.015 to 0.05 W/mK.

The saccharide-based nanoporous Nanosponge materials will have an average pore radius in the nanometric range. The average pore radius shall be in the range of 0.5 to 200 nm.

The saccharide-based nanoporous Nanosponge materials will have particle size in the micrometric range. The particle size shall be in the range of 5 to 500 microns.

The saccharide-based nanoporous Nanosponge materials will have low bulk density. The bulk density shall be in the range of 1 to 1000 kg/m³, and more preferably in the range of 1 to 680 kg/m³.

The methods disclosed in the present invention further allows introduction of one or more functional groups on saccharide-based nanoporous Nanosponge materials.

The said methods allow introduction of functional groups of epoxy, carboxylic acid, carboxylate, sulfo, sulfhydryl, amine, imine, isocyanate, nitrile, silyl and C3 to C21 hydrocarbon groups, and any combinations thereof on saccharide-based nanoporous Nanosponge materials.

In one embodiment, the epoxy group is represented by Chemical Formula (II):

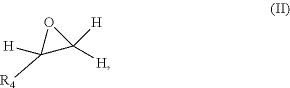

wherein R₄ group is grafted to the monosaccharide unit of the saccharide of Chemical Formula (I).

In another embodiment, the functional group is an amino group comprising the chemical formula —NR₅R₆. The groups R₅, R₆ can comprise any of hydrogen, methyl, ethyl, isopropyl, benzyl and combinations thereof.

In another embodiment, the function group is a sulfo group comprising the chemical formula —SO₃H or —SO₃M₁, where M₁ can be any of sodium (Na⁺), potassium (K⁺), or ammonium (NH₄⁺) cations.

In another embodiment, the function group is a sulfhydryl group comprising the chemical formula —SH or —SM₂, where M₂ can be any of sodium (Na⁺), potassium (K⁺), or ammonium (NH₄⁺) cations.

In another embodiment, the functional group is a silyl group. This shall include silyl ethers comprising the chemical formula —OSiR₇R₈R₉. The groups R₇, R₈, R₉ can comprise any of methyl, ethyl, isobutyl, octyl, phenyl, 3-glycidoxypropyl, 3-methacryloxypropyl, 3-acryloxypropyl, N-2-(aminoethyl)-3-aminopropyl, 3-isocyanatepropyl, 3-mercaptopropyl, vinyl, or another silyl ether comprising the chemical formula —OSiR₇R₈R₉, and combinations thereof.

In another embodiment, the hydrocarbon groups comprise any of octyl, dodecyl, tetradecyl, hexadecyl, octadecyl, eicosyl, docosyl, hexadecenyl, octadecenyl, octadecadienyl, octadecatrienyl, adamantyl, 5,7-dimethyladamantyl, isophorone groups.

Although the cross-linker shall react or cross-link with the monosaccharide unit of the saccharides of nanoporous Nanosponge materials represented by Chemical Formula (I), e.g., the reaction or cross-linking shall occur at R₁, R₂, or R₃ groups, or R₁ and R₂, or R₁ and R₃, or R₂ and R₃, or R₁ and R₂ and R₃ groups of Chemical Formula (I), it is possible that more than one of the functional groups of the said cross-linker, which constitute two or more functional groups, and can be homofunctional or heterofunctional, are left unreacted or intact. It is also possible that new functional groups are generated after the reaction or cross-linking between the functional groups of the said cross-linker and the monosaccharide unit of the saccharides of nanoporous Nanosponge materials represented by Chemical Formula (I). This method therefore introduces new functional groups after reaction or cross-linking.

In one embodiment, the functional group that is introduced by the reaction of cross-linker with the monosaccharide unit of the saccharides of nanoporous Nanosponge materials represented by Chemical Formula (I) includes those of epoxy, carboxylic acid, amine, isocyanate and nitrile groups.

In an exemplary embodiment, the cross-linkers that is used for the said method are trans-2,3-epoxysuccinic acid, pyromellitic anhydride, agaric acid, tricarballylic acid, ethylenediaminetetraacetic dianhydride, ethylenediaminetetraacetic acid (EDTA), ethylenediaminetetraacetic acid disodium salt, aspartic acid, glutamic acid, hexamethylene diisocyanate, toluene 2,4-diisocyanate, isophorone diisocyanate, 1,3-dicyano-2,2-dimethyl-cyclobutane-1,3-dicarboxylic acid.

Surface grafting agents can be optionally added and react with the saccharide-based nanoporous Nanosponges of different saccharides to cross-linker ratios to introduce new functional groups to the nanoporous Nanosponge materials.

The saccharide to surface grafting agent ratio is further defined as the mole ratio of the anhydroglucose unit of the saccharide to surface grafting agent, and is in the range of 1:0.1 to 1:30. Preferably, the mole ratio of the anhydroglucose unit of the saccharide to surface grafting agent is from 1:1 to 1:3.

In one embodiment, the surface grafting agent constitute one or more functional groups, and can be homofunctional or heterofunctional, and the functional groups are preferably epoxy, carboxylic acid, sulfo, sulfhydryl, amine, imine, isocyanate, nitrile, silyl groups or C3 to C21 hydrocarbon groups, and combinations thereof.

In an exemplary embodiment, the surface grafting agents that is used for the said method shall include but not limited to epichlorohydrin, 3-glycidoxypropyl trimethoxysilane, 3-glycidoxypropyl triethoxysilane, phthalic anhydride, 1,8-naphthalic anhydride, (2-Dodecen-1-yl)succinic anhydride, maleic anhydride, 4-sulfo-1,8-naphthalic anhydride potassium salt, 2-sulfobenzoic acid cyclic anhydride, 4-sulfobenzoic acid potassium salt, 3-sulfopropyl acrylate potassium salt, vinylsulfonic acid sodium salt, cyclohexene sulfide, cysteine, glycine, lysine, proline, serine, 3-aminopropyl trimethoxysilane, 3-aminopropyl triethoxysilane, N-2-(aminoethyl)-3-aminopropyl trimethoxysilane, 2-cyano-3-phenylpropionic acid, 2-cyano-2,2-dimethylacetic acid, 2-cyano-4-pyridine carboxylic acid, isophorone diisocyanate, 3-isocyanatepropyl triethoxysilane, dodecyl isocyanate, 1-adamantyl isocyanate, 3-cyanophenyl isocyanate, trimethoxy(methyl)silane, triethoxy(methyl)silane, trimethoxy(ethyl)silane, triethoxy(ethyl)silane, trimethoxy(propyl)silane, triethoxy(propyl)silane, trimethoxy(isobutyl)silane, triethoxy(isobutyl)silane, dimethoxy(dimethyl)silane, diethoxy(dimethyl)silane, trimethoxy(phenyl)silane, triethoxy(phenyl)silane, decanoyl chloride, lauroyl chloride, palmitoyl chloride, myristoyl chloride.

The surface grafting agents shall react with the monosaccharide unit of the saccharides of nanoporous Nanosponge materials represented by Chemical Formula (I). Reaction shall occur at R₁, R₂, or R₃ groups, or R₁ and R₂, or R₁ and R₃, or R₂ and R₃, or R₁ and R₂ and R₃ groups of Chemical Formula (I).

In one embodiment, a solvent system is used during the reaction of monosaccharide unit of the saccharides of nanoporous Nanosponge materials represented by Chemical Formula (I), and is chosen from water, methyl ethyl ketone, tetrahydrofuran, diethyl ether, toluene, xylenes, chlorobenzene, dimethylformamide, dimethylacetamide, dimethyl sulfoxide, propylene carbonate and combination thereof at different mixing ratios.

In another embodiment, the temperature range during the reaction of monosaccharide unit of the saccharides of nanoporous Nanosponge materials represented by Chemical Formula (I) is from −78 to 200 degrees Celsius when a solvent system is used.

In another embodiment, the mixture containing the surface grafting agent and the saccharide-based nanoporous Nanosponges comprise different saccharides to cross-linker ratios can be heated in the absence of solvent in the range of 30 to 200 degrees Celsius.

In another embodiment, the surface grafting agent can be sprayed to the saccharide-based nanoporous Nanosponges comprises different saccharides to cross-linker ratios. This mixture can be heated in the absence of solvent in the range of 30 to 200 degrees Celsius.

Nanoporous Nanosponge materials containing the said functional groups that are introduced according to the methods disclosed are capable to provide different interaction forces such as electrostatic attraction, hydrogen bond formation, hydrophilic interaction, hydrophobic interaction and Van der Waals forces with water, volatile organic vapors (VOCs) and metal ions.

Saccharide-based nanoporous Nanosponge materials containing the said functional groups that are introduced according to the methods disclosed are advantageous, in addition to large inner surface area owing to the presence of nanopores or nanocavities, to provide properties such as thermal insulation, water retention, hydrophobic finishes, odor removal properties, and metal ions exchange or absorption from water or soil based on different interaction forces such as electrostatic attraction, hydrogen bond formation, hydrophilic interaction, hydrophobic interaction and Van der Waals forces with water, volatile organic vapors (VOCs) and metal ions.

Nanoporous Nanosponge materials can have water retention properties. Nanoporous Nanosponge materials containing functional groups including carboxylic acid and/or hydroxyl groups, which are introduced by the methods disclosed, might have water retention value between 1 to 1000% with respect to the weight of said material, and preferably a water retention value between 1 to 520% with respect to the weight of said material.

In another embodiment, nanoporous Nanosponge materials having water retention properties will have pores filled with water in its structure. The resulting material can be a hydrogel or a solid.

Nanoporous Nanosponge materials can be water repellent. Nanoporous Nanosponge materials containing functional groups including silyl groups, or C3 to C21 hydrocarbon groups, which are introduced by the methods disclosed, are water repellent.

According to certain embodiments, nanoporous Nanosponge materials will have low thermal conductivities and can be used as insulation filler materials for thermal insulation applications. However, such materials might absorb moisture in the atmosphere and will increase thermal conductivity values, and might affect insulation performance. The introduction of the said functional groups shall provide water repellent features to these materials when used as insulation filler, thereby providing durability and longevity to the final form factor that is used as thermal insulation materials.

Functional groups that are introduced to the Nanoporous Nanosponge materials by the methods disclosed can provide interaction forces with VOCs. Such nanoporous Nanosponge materials can absorb VOCs, and can have odor removal properties.

VOCs include organic molecules produced by metabolic processes, from human and animal, as well as industrial wastes, effluents, sewage, and related processes; Specific classes of VOCs including sulfidic compounds, comprising sulfides, mercaptans; ammonia or nitrogen containing organic compounds; olefinic compounds, comprising of terpenes and derivative, and organic acids.

In one exemplary embodiment, Nanoporous Nanosponge materials containing carboxylic acid as functional group, which are introduced by the methods disclosed, can absorb ammonia in the range of 1 to 1000 mg/m³ per 1 g of material used. Preferably, the capability of absorbing ammonia is in a concentration of 1 to 600 mg/m³ per 1 g of said material.

Nanoporous Nanosponge materials can have metal ions exchange or absorption properties.

Nanoporous Nanosponge materials containing functional groups including carboxylate, sulfate, thiolate, which are introduced by the methods disclosed, can have metal ions exchange properties, and can exchange metal cations including cadium (Cd), chromium (Cr), lead (Pb), copper (Cu), zinc (Zn), cobalt (Co), mercury (Hg), and/or nickel (Ni) in the range of 0.1 to 1000 cmol of singly charged cation per kilogram of materials used.

In one embodiment, the oxidation states of metal cations that can be exchanged by the said nanoporous Nanosponge materials are Cd (+1), Cr (+2, +3, +6), Pb(+2, +4), Cu (+1, +2), Zn(+2), Co (+1, +3), Hg (+1), Ni(+2).

In another embodiment, nanoporous Nanosponge materials having metal ions exchange properties containing functional groups of carboxylate, sulfo, sulfhydryl, which are introduced by the methods disclosed, shall accompany with a cation of any of sodium (Na⁺), potassium (K⁺), or ammonium (NH₄⁺).

Nanoporous Nanosponge materials containing functional groups of imine, amine or nitrile, which are introduced by the methods disclosed, can absorb metal ions including cadium (Cd), chromium (Cr), lead (Pb), copper (Cu), zinc (Zn), cobalt (Co), mercury (Hg), and/or nickel (Ni) in the range of 0.1 to 1000 cmol of singly charged cation per kilogram of materials used.

In one embodiment, the oxidation states of metal cations that can be absorbed by the said nanoporous Nanosponge materials are Cd (+1), Cr (+2, +3, +6), Pb(+2, +4), Cu (+1, +2), Zn(+2), Co (+1, +3), Hg (+1), Ni(+2).

In another embodiment, the nanoporous Nanosponge materials containing functional groups of carboxylate, sulfo, sulfhydryl, imine, amine or nitrile which are introduced by the methods disclosed, can exchange or absorb metal ions including cadium (Cd), chromium (Cr), lead (Pb), copper (Cu), zinc (Zn), cobalt (Co), mercury (Hg), and/or nickel (Ni) in the range of 0.1 to 1000 cmol of singly charged cation per kilogram of materials used.

In one embodiment, the oxidation states of metal cations that can be exchanged or absorbed by the said nanoporous Nanosponge materials are Cd (+1), Cr (+2, +3, +6), Pb(+2, +4), Cu (+1, +2), Zn(+2), Co (+1, +3), Hg (+1), Ni(+2).

In another embodiment, the metal cations in nanoporous Nanosponge materials having metal ions exchange or absorption properties containing functional groups of carboxylate, sulfo, sulfhydryl, which are introduced by the methods disclosed, shall accompany with a cation of any of sodium (Na⁺), potassium (K⁺), or ammonium (NH₄⁺).

In certain embodiment, nanoporous Nanosponge materials can have water retention properties and metal ion exchange or absorption properties. Such materials, when brings in contact with water containing metal ions, is capable to form a hydrogel and exchange or absorb metal ions from water. This material shall find applications in metal ions exchange or absorption from water or soil.

In an exemplary embodiment, nanoporous Nanosponge materials having water retention properties and metal ion exchange or absorption properties comprise carboxylate and amine functional groups.

### EXAMPLES

Examples will be used below to illustrate the invention. It will be understood that these examples should not be construed as in any way limiting the scope of the invention.

### Fabrication and Physical and Thermal Properties of Saccharide-Based Nanoporous Nanosponge Materials

### Example 1

The reaction between 1 equivalent of beta-cyclodextrin and 4 equivalent of toluene diisocyanate (TDI) in dimethylformamide (DMF) (equivalent to saccharide to cross-linker ratio of 1:0.57) at 40 degrees Celsius for 15 minutes to 19 hours led to the formation of a sol-gel. The sol-gel that filled with DMF then underwent repeated solvent exchange with acetone such that the said sol-gel was filled with acetone. Further repeated solvent exchange was performed using a hydrofluorether, 3M™ Novec™ 7100. The final sol-gel filled with the said hydrofluorether was allowed to dry under ambient temperature and pressure for 1 day. The resulting nanoporous Nanosponge material was then isolated as flakes and characterized, with physical and thermal properties tabulated in TABLE 1, including Barrett-Joyner-Halenda (BJH) Analysis to pore radius distribution.

### Example 2

The reaction between 1 equivalent of beta-cyclodextrin and 4 equivalent of toluene diisocyanate (TDI) in DMF (equivalent to saccharide to cross-linker ratio of 1:0.57) at 50 degrees Celsius for 19 hours led to the formation of a sol-gel. The drying methods were similar to that described in Example 1. The resulting nanoporous Nanosponge material was then isolated as flakes and characterized, with physical and thermal properties tabulated in TABLE 1.

TABLE 1
Physical and Thermal Properties of Saccharide-based Nanoporous
Nanosponge Materials

| | | Thermal | |
|---|---|---|---|
| | Bulk Density | Conductivity | BJH Pore Radius |
| | (kg/m³) | (W/mK) | Distribution (nm) |
| Example 1 | 292 | 0.035 | 5 to 82 |
| Example 2 | 680 | 0.029 | — |

### Water Retention Properties

### Example 3

A pre-weighted nanoporous Nanosponge material from Example 1 was placed in deionized water at room temperature for 24 hours. It was then removed from the water, and all of the surface moisture of the material was dried with a filter paper. This material was weighted for the assessment of its water retention capability, with results tabulated in TABLE 2.

### Example 4

Beta-cyclodextrin and poly(acrylic acid) at a saccharide to cross-linker ratio (the moles of cross-linker taken as the monomer unit of poly(acrylic acid) of 1:0.64 were mixed in deionized water at 70 degrees Celsius. The mixture was then heated at 130 degrees Celsius for 2 hours leading to the formation of a brown-colored material. The material was washed few times with water and dried to afford a pale-brown solid. The water retention capability was determined using the methods provided by Example, with results tabulated in TABLE 2.

TABLE 2
Water Retention Properties of Saccharide-based Nanoporous
Nanosponge Materials

| | | | Water Retention |
|---|---|---|---|
| | Initial Weight (g) | Final Weight (g) | Value (%) |
| Example 1 | 0.3723 | 1.015 | 172 |
| Example 4 | 0.0621 | 0.3850 | 520 |

### Water Repellent Properties

### Example 5

Microcrystalline cellulose with molecular weight of about 30,000 was first dispersed in toluene. Lauroyl chloride as surface grafting agent with saccharide to surface grafting agent at 1:3, and triethylamine, were added to this dispersion at room temperature, was mixed for 1 hour. The resulting mixture was centrifuged and washed with using ethanol and water. This mixture in water was dried by using freeze-drying method. A white colored material was isolated and obtained, and the physical and thermal properties were measured and tabulated in TABLE 3. A water droplet was placed on this material, and the shape of the droplet was retained for at least 1 day. The water contact angle was measured to be at 140°.

### Comparative Example 1

Microcrystalline cellulose with molecular weight of about 30,000 was first dispersed in water for 24 hours. This mixture in water was dried by using freeze-drying method. A white colored material was isolated and obtained, and the physical and thermal properties were measured and tabulated in TABLE 3. A water droplet was placed on this material, and this droplet was immediately absorbed by this material.

TABLE 3
Physical, Thermal and Water Repellent Properties of
Saccharide-based Nanoporous
Nanosponge Materials

| | | Thermal | Retention of Shape |
|---|---|---|---|
| | Bulk Density | Conductivity | of Water Droplet On |
| | (kg/m³) | (W/mK) | Top of Material |
| Example 5 | 32 | 0.032 | At least for 1 day |
| Comparative | 13 | 0.026 | Immediately absorbed |
| Example 1 | | | by material |

### Fabrication and Volatile Organic Compounds (VOCs) Absorption Properties of Saccharide-Based Nanoporous Nanosponge Materials

### Example 6

The reaction between 1 equivalent of beta-cyclodextrin and 4 equivalent of pyromellitic dianhydride in DMF (equivalent to saccharide to cross-linker ratio of 1:0.57) at 100 degrees Celsius for 10 hours led to formation of a viscous solution. Ethanol was added to induce precipitation and a white-colored material was obtained and isolated. Carboxylic acid groups of this material were identified by the presence of the stretching signals of the corresponding Fourier-transform infrared spectroscopy (FTIR) spectrum from 2500 to 3000 cm⁻¹.

### Example 7

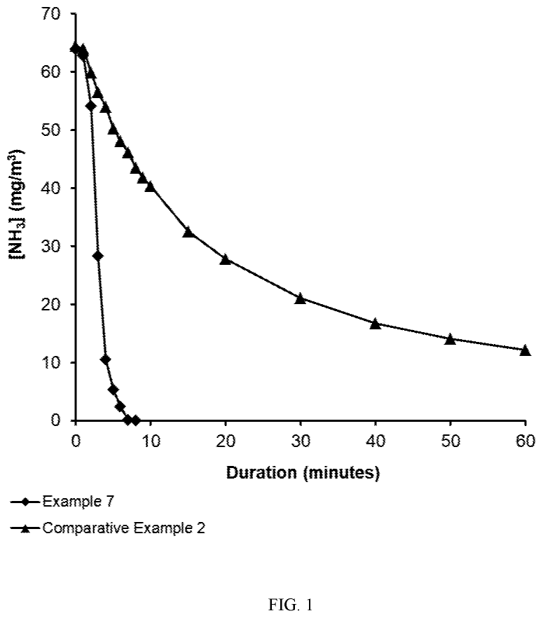

Nanoporous Nanosponge material of Example 6 was placed in a test chamber filled with ammonia at initial concentration at 63.9 mg/m³. It was found that 1 g of the material absorbed 63.9 mg/m³ of ammonia in 8 minutes. FIG. 1 depicts the absorption profile of Example 5 towards ammonia.

### Comparative Example 2

Active carbon was placed was placed in a test chamber filled with ammonia at initial concentration at 64.5 mg/m³. It was found that 1 g of the material absorbed 21.0 mg/m³ of ammonia in 8 minutes, and 52.3 mg/m³ of ammonia in 60 minutes. FIG. 1 depicts the absorption profile of active carbon towards ammonia, while TABLE 4 comparing the results of absorption properties toward ammonia.

TABLE 4
Absorption Properties Towards Ammonia

| | | Absorption | Absorption |
|---|---|---|---|
| | | Capability | Capability |
| | | at 8 minutes | at 60 minutes |
| | Initial | per gram of | per gram of |
| | Concentration | materials | materials |
| | (mg/m³) | (mg/m³) | (mg/m³) |
| Example 7 | 63.9 | 63.9 | 63.9 |
| Comparative | 64.5 | 21.0 | 52.3 |
| Example 2 | | | |

### Example 8

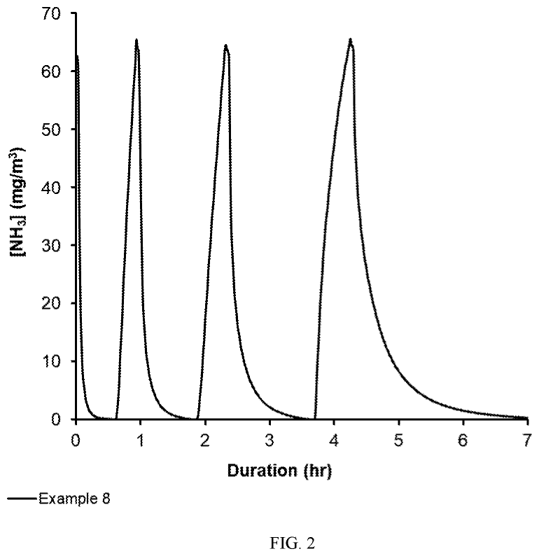

Nanoporous Nanosponge material of Example 6 was placed in a test chamber filled with ammonia at initial concentration at 62.7 mg/m³. It was found that 1 g of the material absorbed 61.8 mg/m³ of ammonia in 15 minutes. This spent material was subjected to ammonia at concentration at 65.5 mg/m³ again, and was found that the material can further absorb 64.5 mg/m³ of ammonia in 32 minutes. Two additional absorption trials for the spent materials were performed, and it was found that the said material can remove a total of 258.2 mg/m³ of ammonia. FIG. 2 depicts the absorption profile of Example 5 towards ammonia. TABLE 5 tabulated the results of absorption towards ammonia.

TABLE 5
Absorption Properties Towards Ammonia

| | | Absorption | |
|---|---|---|---|
| | | Capability | |
| | Initial | per gram of | |
| | Concentration | materials | Time Required |
| | (mg/m³) | (mg/m³) | (Minutes) |
| 1^{st} Trial | 62.7 | 61.8 | 15 |
| 2^{nd} Trial | 65.5 | 64.5 | 32 |
| 3^{rd} Trial | 64.5 | 63.7 | 56 |
| 4^{th} Trial | 65.6 | 64.7 | 125 |

### Fabrication and Metal Ions Exchange Properties of Saccharide-Based Nanoporous Nanosponge Materials

### Example 9

Microcrystalline cellulose with molecular weight of about 30,000 and ethylenediamine-tetraacetic acid disodium salt dehydrate (EDTANa₂.H₂O) at saccharide to cross-linker ratio of 1.1 were mixed in deionized water for 1 hour. The mixture was then heated at 155 degrees Celsius for 5 hours leading to the formation of a brown-colored material. The material was washed few times with water and dried to afford a pale-brown solid. The metal ions exchange properties of the said material was quantified by back titration using oxalic acid as standard solution. The metal ion exchanged capability is calculated to be 43.2 cmol of singly-charged cation per kilogram of materials used.

What is claimed is:

1. A cross-linked nanoporous saccharide-based material having monosaccharide unit represented by chemical formula (I): 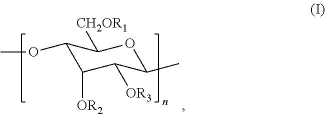
wherein R₁, R₂, R₃ is independently selected from hydrogen, methyl, ethyl, butyl, pentyl, octyl, acetyl, propionate, butyrate, benzoyl, phthalate, 2-hydroxyethyl, 2-hydroxypropyl, carboxymethyl, carboxymethyl sodium, 2-carboxyethyl sodium, sulfated sodium, t-butyldimethylsilyl, or cyanoethyl group; n is an integer from 6 to 1,300; and
said material has an average pore radius in a range of 0.5 to 200 nm, particle size in a range of 5 to 500 microns, bulk density in a range of 1 to 680 kg/m³, thermal conductivity from 0.015 to 0.05 W/mK, and
said material is functionalized with one or more of a water retention capability from 1 to 520% with respect to the weight thereof, a water-repellent capability with a water contact angle at 140°, capability of absorbing ammonia in a range of 1 to 600 mg/m³ per 1 g of said material, capabilities of exchanging and absorbing metal ions including Cd, Cr, Pb, Cu, Zn, Co, Hg and/or Ni in a range of 0.1 to 1000 cmol of singly charged cation per kg of said material; and
said material is obtainable by reacting said saccharide with one or more cross-linkers of the same kind or different kind at a mole ratio of anhydroglucose unit of the saccharide to cross-linker in a range of 1:0.25 to 1:5 in one-pot and in a solvent system, followed by drying of the nanoporous saccharide-based material, wherein the one or more cross-linkers introduce two or more homofunctional or heterofunctional groups selected from carboxylic acid or carboxylic acid anhydride groups, isocyanate or thiocyanate groups, vinyl groups, silyl groups, epoxy, sulfo, sulfhydryl, or amine groups, to said saccharide.

2. The cross-linked nanoporous saccharide-based material of claim 1, wherein said saccharide comprises alpha-glycosidic bond or beta-glycosidic bond.

3. The cross-linked nanoporous saccharide-based material of claim 1, wherein said saccharide is selected from cellulose, dextrin or cyclodextrins, or the derivatives thereof.

4. The cross-linked nanoporous saccharide-based material of claim 3, wherein n is in a range of 6-8 when said saccharide is selected from cyclodextrins or the derivatives thereof.

5. The cross-linked nanoporous saccharide-based material of claim 3, wherein n is in a range of range of 120 to 1300 when said saccharide is selected from cellulose or the derivatives thereof.

6. The cross-linked nanoporous saccharide-based material of claim 3, wherein said cyclodextrins derivatives are selected from alpha-, beta-, or gamma-cyclodextrins.

7. The cross-linked nanoporous saccharide-based material of claim 1, wherein said reaction and drying are carried out under a temperature ranging from −78 to 200 degree Celsius.

8. The cross-linked nanoporous saccharide-based material of claim 1, wherein prior to said drying, the solvent system is replaced by a low surface tension solvent system to obtain a nanoporous sol-gel filled with said low surface tension solvent.

9. The cross-linked nanoporous saccharide-based material of claim 8, wherein said low surface tension solvent system comprises components of hydrofluoroethers.

10. The cross-linked nanoporous saccharide-based material of claim 9, wherein said nanoporous sol-gel is filled with said components of hydrofluoroethers, which is dried at ambient temperature and pressure or under supercritical conditions.

11. A method for fabricating the cross-linked nanoporous saccharide-based material of claim 1, comprising:
reacting said saccharides with one or more cross-linkers of the same kind or different kind by mixing said saccharides with the one or more cross-linkers at a mole ratio of anhydroglucose unit of the saccharide to cross-linker in a range of 1:0.25 to 1:5 in one-pot and in a solvent system under a temperature ranging from −78 to 200 degrees Celsius;
drying the reaction mixture to obtain the cross-linked nanoporous saccharide-based material.

12. The method of claim 11, further comprising:
introducing one or more functional groups to the saccharides by reacting one or more of cross-linkers with the monosaccharide unit of the saccharides at a mole ratio of anhydroglucose unit of the saccharide to cross-linker in a range of 1:0.25 to 1:5 during said reaction and prior to said drying.

13. The method of claim 11, further comprising:
introducing one or more functional groups to the saccharides by reacting one or more surface grafting agents at a mole ratio of an anhydroglucose unit of the saccharide to surface grafting agent in a range of 1:1 to 1:3 during said reaction, prior to and/or after said drying.

14. The method of claim 11, further comprising:
replacing the solvent system by a low surface tension solvent system prior to said drying to obtain a nanoporous sol-gel, wherein the said low surface tension solvent system comprises components of hydrofluoroethers such that the nanoporous sol-gel is filled with said components of hydrofluoroethers.

15. The method of claim 14, wherein the nanoporous sol-gel filled with the components of hydrofluoroethers is dried at ambient temperature and pressure, or under supercritical conditions.

16. The method of claim 15, wherein the dried nanoporous sol-gel is cured at a temperature from 30 to 200 degrees Celsius.

17. The method of any one of claims 11 to 16, wherein said one or more functional groups introduced by said surface grafting agents comprise epoxy, carboxylic acid, carboxylate, sulfo, sulfhydryl, amine, imine, isocyanate, nitrile, silyl and C3 to C21 hydrocarbon groups, or any combinations thereof.

18. The method of claim 17, wherein said carboxylic acid or hydroxyl groups provide said material with a water retention value from 1 to 520% with respect to the weight of said material.

19. The method of claim 17, wherein said silyl groups or C3 to C21 hydrocarbon groups provide said material with a water-repellent capability.

20. The method of claim 19, wherein said material has a water contact angle at 140°.

21. The method of claim 17, wherein said carboxylic acid group provides said material with capability of absorbing ammonia in a range of 1 to 600 mg/m³ per 1 g of said material.

22. The method of claim 17, wherein said carboxylate, sulfo, sulfhydryl, imine, amine or nitrile groups provide said material with capabilities of metal ions exchange and absorption.

23. The method of claim 22, wherein said metal ions being exchanged and absorbed by said material comprise Cd, Cr, Pb, Cu, Zn, Co, Hg and/or Ni, and said metal ions exchange and absorption is in a range of 0.1 to 1000 cmol of singly charged cation per kg of said material.

24. A thermally insulating and absorbing nanosponge for gas or liquid comprising the material according to any one of claims 1 to 10 with one or more of thermal insulation, water retention, hydrophobic finishes, odor removal, and metal ions exchange and absorption properties.

25. A thermally insulating and absorbing nanosponge for gas or liquid fabricated by the method according to any one of claims 11 to 23 with one or more of thermal insulation, water retention, hydrophobic finishes, odor removal, and metal ions exchange and absorption properties.
